(19) United States
(12) Patent Application Publication
(10) Pub. No.: US 2025/0220131 A1
(43) Pub. Date: Jul. 3, 2025

(54) IMAGING DEVICE, IMAGING METHOD, AND PROGRAM

(71) Applicant: SONY GROUP CORPORATION, TOKYO (JP)

(72) Inventors: ASAKO FUKUTSUKA, TOKYO (JP); ATSUSHI MASUDA, TOKYO (JP); SHUNPEI KUMAKIRI, TOKYO (JP)

(21) Appl. No.: 18/847,853

(22) PCT Filed: Mar. 6, 2023
(86) PCT No.: PCT/JP2023/008365

§ 371 Date: Sep. 17, 2024

(30) Foreign Application Priority Data
Mar. 24, 2022 (JP) 2022-047950

(51) Int. Cl. H04N 5/76; G10L 21/028; G10L 21/034; G10L 21/0364; G10L 25/57; H04N 23/611; H04N 23/67

(52) U.S. Cl. CPC H04N 5/76; G10L 21/028; G10L 21/034; G10L 21/0364; G10L 25/57; H04N 23/611; H04N 23/67

(57) ABSTRACT

The present technology relates to an imaging device, an imaging method, and a program capable of easily recording a voice of a specific person together with a specific sound as audio data of a moving image. An imaging device according to one aspect of the present technology separates a voice of a specific person and a specific sound other than the voice of the specific person from a recorded sound recorded when a moving image is captured, and records the voice of the specific person together with the specific sound as audio data of the moving image. The present technology can be applied to a camera having a function of capturing a moving image.

### TECHNICAL FIELD

The present technology relates to an imaging device, an imaging method, and a program, and more particularly, to an imaging device, an imaging method, and a program capable of easily recording a voice of a specific person together with a specific sound as audio data of a moving image.

### BACKGROUND ART

Video distribution by an individual using a social networking service (SNS) or the like has become widespread. As imaging of such a video for distribution, imaging of a scene in which a person as a subject is speaking to a camera or the like is often performed.

### CITATION LIST

### Patent Document

Patent Document 1: Japanese Patent Application Laid-Open No. 2020-187346
Patent Document 2: WO 2021/033222 A

### SUMMARY OF THE INVENTION

### Problems to be Solved by the Invention

In general, a microphone (microphone) built in an imaging device such as a camera is a non-directional microphone. Therefore, it is difficult to record only a specific sound such as a voice of a person who is a subject.

In a case where a unidirectional external microphone is attached to the camera and used, it is possible to record only a voice of a person of the subject included in the directivity range, but it is difficult to simultaneously record the environmental sound. In a case where it is desired to record only the voice of the person of the subject and the environmental sound, it is necessary to separately capture the voice of the person of the subject and the environmental sound.

The present technology has been made in view of such a situation, and an object thereof is to easily record a voice of a specific person together with a specific sound as audio data of a moving image.

### Solutions to Problems

An imaging device according to one aspect of the present technology includes: an audio processing unit that separates a voice of a specific person and a specific sound other than the voice of the specific person from a recorded sound recorded when a moving image is captured; and a recording processing unit that records the voice of the specific person together with the specific sound as audio data of the moving image.

In one aspect of the present technology, a voice of a specific person and a specific sound other than the voice of the specific person are separated from a recorded sound recorded when a moving image is captured, and the voice of the specific person is recorded together with the specific sound as audio data of the moving image.

### BRIEF DESCRIPTION OF DRAWINGS

FIG. 1 is a diagram illustrating an example of imaging using an imaging device according to an embodiment of the present technology.

FIG. 2 is a diagram illustrating an example of audio recording of the imaging device.

FIG. 3 is a diagram illustrating an example of an audio recording mode.

FIG. 4 is a view illustrating a display example of a setting screen of the audio recording mode.

FIG. 5 is a diagram illustrating a display example of a shooting screen when the mode is set to AF priority.

FIG. 6 is a diagram illustrating another display example of the shooting screen when the mode is set to the AF priority.

FIG. 7 is a diagram illustrating a display example of a shooting screen when the mode is set to registration priority.

FIG. 8 is a block diagram illustrating a hardware configuration example of the imaging device.

FIG. 9 is a block diagram illustrating a functional configuration example of a control unit.

FIG. 10 is a diagram illustrating an example of voice separation.

FIG. 11 is a flowchart for explaining processing of the imaging device.

FIG. 12 is a flowchart illustrating AF priority audio recording processing performed in step S3 in FIG. 11.

FIG. 13 is a flowchart illustrating registration priority audio recording processing performed in step S4 in FIG. 11.

FIG. 14 is a diagram illustrating a display example of an editing screen after image capturing.

FIG. 15 is a diagram illustrating a display example of a volume setting screen.

FIG. 16 is a block diagram illustrating a functional configuration example of an information processing unit.

FIG. 17 is a flowchart for explaining processing of the imaging device.

### MODE FOR CARRYING OUT THE INVENTION

Hereinafter, modes for carrying out the present technology will be described. The description is given in the following order.
1. First Embodiment (Example of Real-Time Recording)
2. Second Embodiment (Example of Editing after Image Capturing)
3. Modifications

### First Embodiment (Example of Real-Time Recording)

### Overview of Present Technology

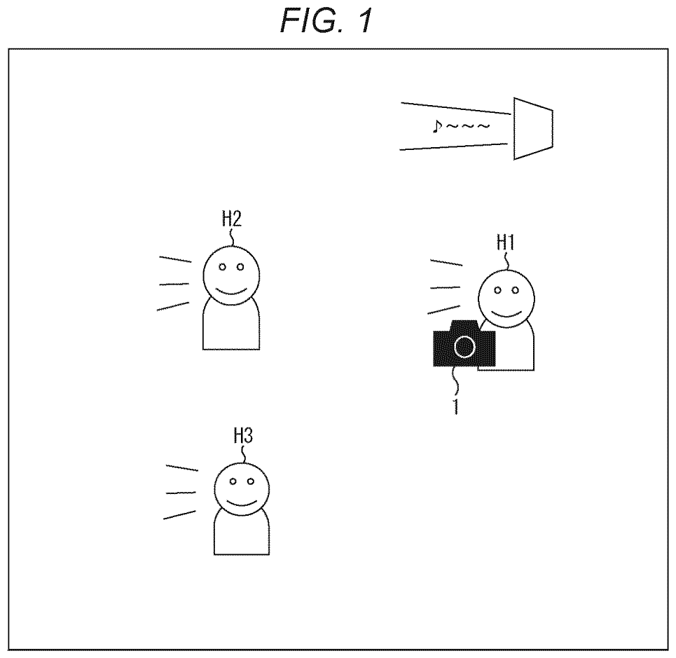

FIG. 1 is a diagram illustrating an example of imaging using an imaging device 1 according to an embodiment of the present technology.

The imaging device 1 is a device having a function of capturing a moving image, such as a digital camera or a smartphone. The microphone of the imaging device 1 is, for example, a non-directional microphone. In the example of FIG. 1, a person H1 who is a user of the imaging device 1 is a videographer, and a moving image showing a person H2 is being captured. Hereinafter, the person H1 is appropriately referred to as a videographer H1, and the person H2 is appropriately referred to as a subject H2.

During imaging of the subject H2, for example, the videographer H1 speaks to the subject H2 to instruct the imaging content. Furthermore, the subject H2 makes utterances such as lines. The recorded sound captured by the imaging device 1 includes a voice of the subject H2 together with a voice of the videographer H1.

In the example of FIG. 1, a person H3 who is a person other than the subject is talking with another person (not illustrated) near the subject H2. Furthermore, as schematically illustrated in the upper right part of FIG. 1 using an illustration of a speaker, an environmental sound, which is a sound other than the voice of a person, such as a wave sound, a wind sound, or BGM, can be heard at the shooting site. The recorded sound includes not only the voice of the videographer H1 and the voice of the subject H2 but also the voice of the person H3 and the environmental sound.

For example, the scene that the videographer H1 wants to capture is a scene where the subject H2 is uttering a line while the environmental sound is heard. The sound that the videographer H1 wants to record as the audio of such a scene is only the voice of the subject H2 and the environmental sound.

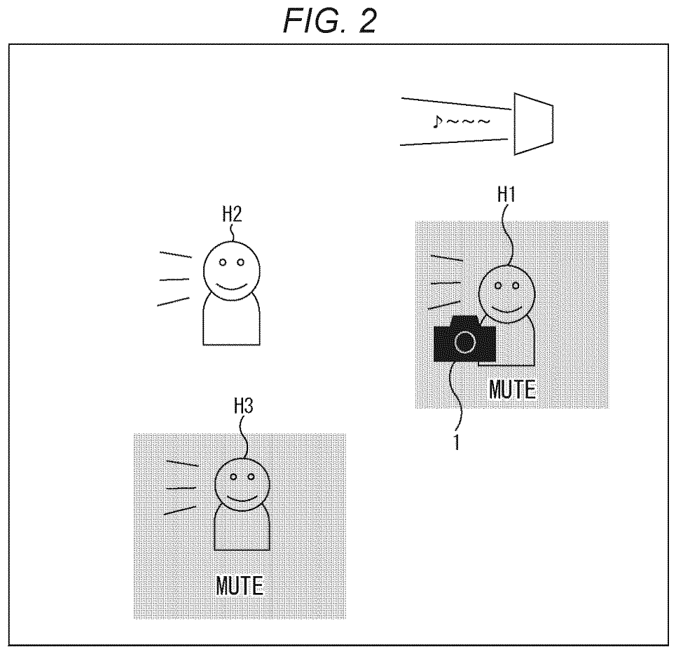

In the imaging device 1, the voice of the subject H2 who is a specific person designated by the videographer H1 and the environmental sound, which is a specific sound other than the voice of the subject H2, are separated from the recorded sound captured at the time of capturing the moving image, and are recorded as the audio of the moving image. For example, separation and recording of the sound are performed in real time during capturing of a moving image. The voice of the videographer H1 himself/herself and the voice of the person H3, which are the voices of the persons other than the subject H2 designated by the videographer H1, are muted (not recorded) as illustrated with colors in FIG. 2, for example.

For example, the voice of the subject H2 is recorded with a volume larger than the environmental sound. The volume of the sound to be recorded is appropriately set by the videographer H1.

In this manner, the videographer H1 can record only the voice of the specific person designated by the videographer H1 and the environmental sound as the audio of the moving image by capturing the image using the imaging device 1.

### <Audio Recording Mode>

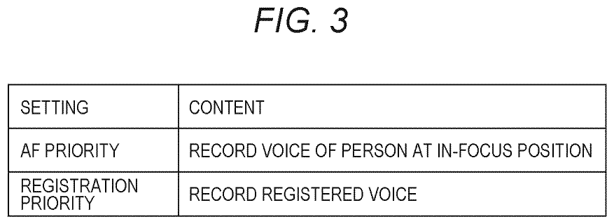

FIG. 3 is a diagram illustrating an example of an audio recording mode.

As illustrated in FIG. 3, in the imaging device 1, two modes of AF priority and registration priority are prepared as audio recording modes that are modes related to audio recording.

The AF priority is a mode for recording the voice of the person at the in-focus position. When the mode is set to the AF priority, the voice of the person at the in-focus position is recorded together with the environmental sound. The imaging device 1 is a device equipped with an AF function.

The registration priority is a mode for recording the voice of a person registered in advance in the imaging device 1. When the mode is set to the registration priority, the voice of the registered person is recorded together with the environmental sound.

The user (videographer H1) selects one of the two audio recording modes and starts capturing a moving image. For example, the AF priority is set as the default audio recording mode.

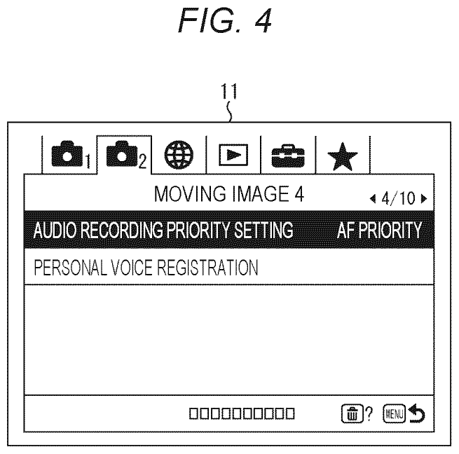

FIG. 4 is a view illustrating a display example of a setting screen of the audio recording mode.

In a case where the user selects to set the audio recording mode by operating a button provided on the housing of the imaging device 1 or the like, a setting screen as illustrated in FIG. 4 is displayed on a display 11 of the imaging device 1.

In a case where a tab related to capturing of a moving image is selected from the tabs arranged at the upper part of the screen, the items of “audio recording priority setting” and “personal voice registration” are displayed as illustrated in FIG. 4.

“Audio recording priority setting” is an item related to setting of the audio recording mode. In the example of FIG. 4, the audio recording mode is set to “AF priority”. The videographer can select either the “AF priority” mode or the “registration priority” mode as the audio recording mode by operating the item of “audio recording priority setting”. The display 11 is, for example, a display equipped with a touch panel.

“Personal voice registration” is an item selected when a voice is registered. In a case where the item of “personal voice registration” is selected, a voice registration screen is displayed, which is a state in which the voice of a specific person can be registered. The voice of a specific person such as the subject H2 captured by the microphone in this state is registered in the imaging device 1.

In a case where “registration priority” is set as the audio recording mode, the voice selected from among voices registered using “personal voice registration” is recorded. For example, voices of a plurality of persons can be registered in the imaging device 1.

Here, imaging using each audio recording mode set using such a setting screen will be described.

### <Audio Recording Mode: AF Priority>

### AF Priority (Default)

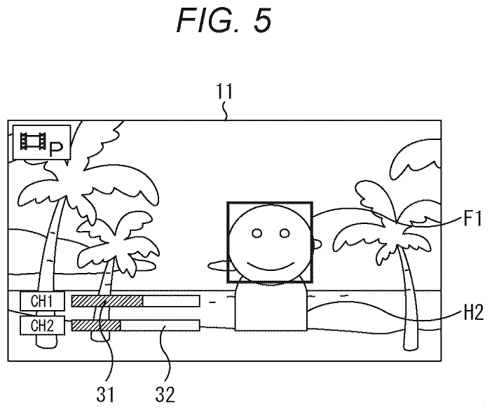

FIG. 5 is a diagram illustrating a display example of a shooting screen when the mode is set to the AF priority.

When a moving image is captured, a through image that is a moving image being captured is displayed on the shooting screen. In the example of FIG. 5, an image showing the subject H2 on the sand beach is displayed. Various types of information such as information regarding imaging are displayed in superposition with the image showing the subject H2.

As illustrated in FIG. 5, an AF frame F1 is displayed in accordance with the face of the subject H2. In the imaging device 1, face recognition is performed on the captured image, and AF control is performed so as to focus on one of the recognized faces.

As will be described later, in the imaging device 1, the voice of the subject H2 is separated from the recorded sound on the basis of the position information of the subject H2 specified on the basis of the in-focus position and the analysis result of the motion of the mouth of the subject H2. The separated voice of the subject H2 is recorded as the voice of the specific person together with the environmental sound.

At the lower left of the shooting screen, level meters 31 and 32 indicating the respective volumes of a channel 1 and a channel 2, which are audio channels, are displayed. For example, the voice of the subject H2 is recorded as the audio of the channel 1, and the environmental sound is recorded as the audio of the channel 2.

### AF Priority (Manual)

When the mode is set to the AF priority, it is possible to select recording of a voice of a person different from a person to be subjected to AF. The selection of a person as a voice recording target is performed, for example, such that the user selects a face of a specific person from among faces of persons displayed on the shooting screen.

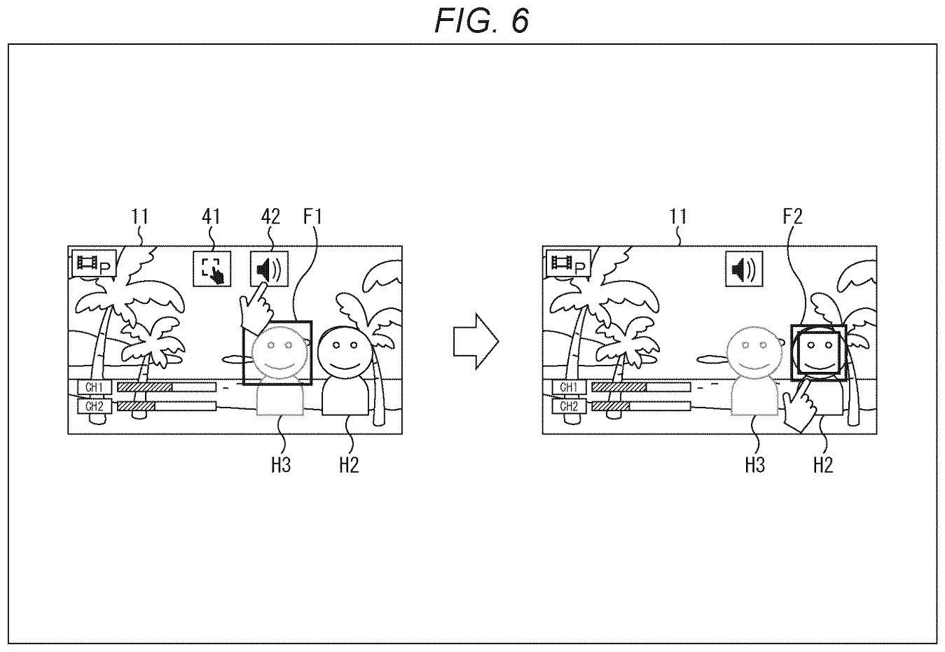

FIG. 6 is a diagram illustrating a display example of a shooting screen when the mode is set to the AF priority.

On the left side of FIG. 6, an image showing a person H3 who is a person other than the subject H2 is displayed together with the subject H2. Furthermore, AF control is performed so as to focus on the face of the person H3, and the AF frame F1 is displayed in accordance with the face of the person H3.

An icon 41 and an icon 42 are displayed side by side at the upper part of the shooting screen. The icon 41 is an icon operated when a touch AF function is turned on. The touch AF is a function that allows the user to select the face of a person to be subjected to AF.

The icon 42 is an icon operated when a touch sound capturing is turned on. The touch sound capturing is a function that allows the user to select the face of a person as a voice recording target.

In a case where the icon 42 is operated as illustrated on the left side of FIG. 6 and the face of the subject H2 is subsequently selected, the voice recording target is set to the subject H2, and a recording target frame F2 is displayed in accordance with the face of the subject H2 as illustrated on the right side of FIG. 6. The recording target frame F2 indicates who the person whose voice is to be recorded is. The recording target frame F2 is displayed as a frame having a color and a shape different from those of the AF frame F1. At this time, the AF target remains the face of the person H3.

In the imaging device 1, the voice of the subject H2 selected by the videographer H1 is separated as the voice of a specific person and recorded together with the environmental sound. As described above, the touch sound capturing function is used when the user manually (manually) selects a person different from a person to be subjected to AF as a voice recording target. By using the AF priority touch sound capturing function, the user can record the voice of a person different from the person to be subjected to AF.

### <Audio Recording Mode: Registration Priority>

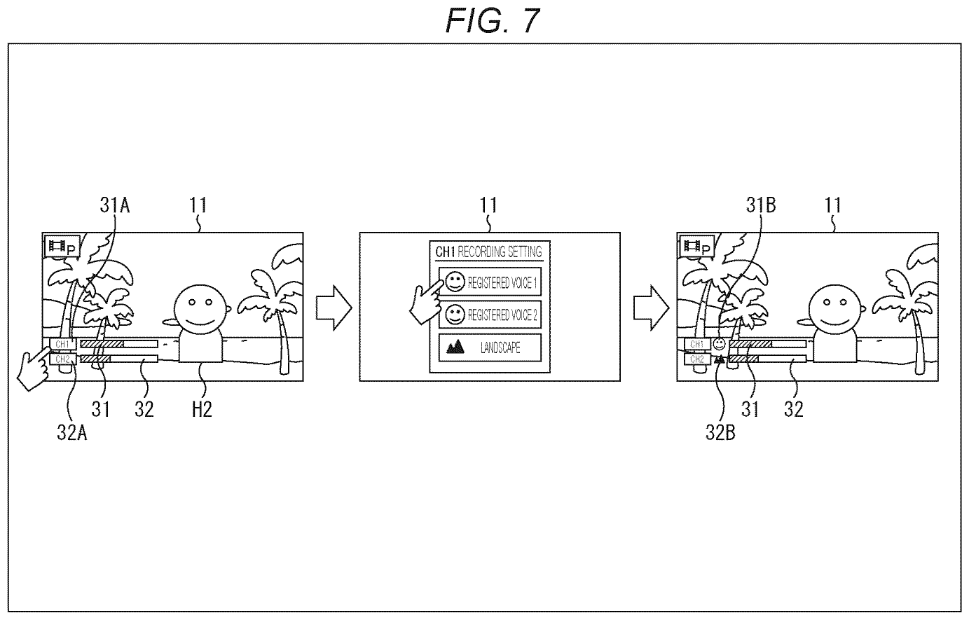

FIG. 7 is a diagram illustrating a display example of a shooting screen when the mode is set to the registration priority. Description overlapping with the above description will be appropriately omitted.

In a case where an icon 31A of the level meter 31 indicating the volume of the channel 1 is selected as illustrated on the left side of FIG. 7 while the voice of the person to be recorded is registered in advance using the function of “personal voice registration”, the setting screen of the channel 1 is displayed as illustrated in the center of FIG. 7. Similarly, in a case where an icon 32A of the level meter 32 is selected, the setting screen of the channel 2 is displayed. The setting screen of the channel 1 is a screen used to select audio to be recorded as the audio of the channel 1. The selection of the audio is performed by selecting one voice from the registered voices.

In the example in the center of FIG. 7, “registered voice 1” and “registered voice 2” are displayed as the registered voices. In a case where “registered voice 1” is selected, the same voice as the voice registered as “registered voice 1” is recorded in the channel 1, and in a case where “registered voice 2” is selected, the same voice as the voice registered as “registered voice 2” is recorded in the channel 1. For example, “registered voice 1” is a voice of the subject H2, and “registered voice 2” is a voice of the person H3.

In the example of FIG. 7, “landscape” can be selected in addition to “registered voice 1” and “registered voice 2”.

As illustrated in FIG. 7, in a case where “registered voice 1” is selected using the setting screen of the channel 1, recording of the voice of the subject H2 separated from the recorded sound is started.

At this time, as illustrated on the right side of FIG. 7, an icon 31B is displayed next to the level meter 31. The icon 31B indicates that the voice of the person (subject H2) with “registered voice 1” is recorded as the voice of the channel 1.

In the example on the right side of FIG. 7, an icon 32B indicating that the environmental sound is recorded as the audio of the channel 2 is displayed next to the level meter 32. The icon 32B is displayed in a case where “landscape” is selected on the setting screen of the channel 2.

In this manner, by setting the registration priority as the audio recording mode, the user (videographer H1) can record, for example, his/her own voice not shown in the moving image being captured as the voice of the specific person together with the environmental sound.

A series of operations of the imaging device 1, the operations recording only the voice of a specific person and the environmental sound according to the audio recording mode as described above will be described later with reference to the flowchart.

### <Configuration of Imaging Device 1>

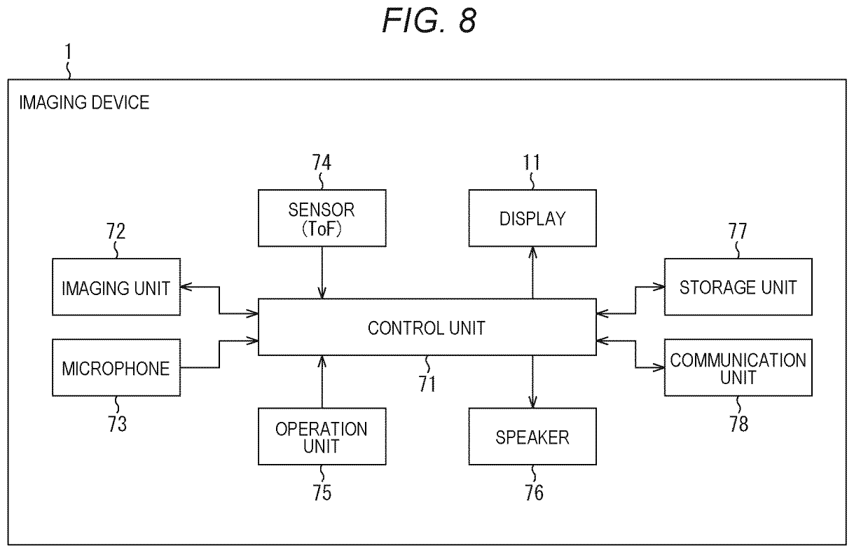

FIG. 8 is a block diagram illustrating a hardware configuration example of the imaging device 1.

In addition to the display 11 described above, the imaging device 1 is configured by connecting an imaging unit 72, a microphone 73, a sensor 74, an operation unit 75, a speaker 76, a storage unit 77, and a communication unit 78 to a control unit 71.

The display 11 includes an LCD or the like, and displays the above-described screen under the control of the control unit 71.

The control unit 71 includes a central processing unit (CPU), a read only memory (ROM), and a random access memory (RAM), and the like. The control unit 71 executes a predetermined program and controls the entire operation of the imaging device 1 according to the operation of the user.

The imaging unit 72 includes a lens, an imaging element, and the like, and performs imaging under the control of the control unit 71. The imaging unit 72 outputs data of a moving image obtained by the imaging to the control unit 71.

The microphone 73 outputs audio data such as captured sound to the control unit 71.

The sensor 74 includes a ToF sensor or the like. The sensor 74 measures a distance to each position of the subjects included in the imaging range, and outputs sensor data to the control unit 71.

The operation unit 75 includes an operation button, a touch panel, or the like provided on the surface of the housing of the imaging device 1. The operation unit 75 outputs information indicating the content of the user's operation to the control unit 71.

The speaker 76 outputs audio on the basis of an audio signal supplied from the control unit 71.

The storage unit 77 includes a flash memory or a memory card inserted into a card slot provided in the housing. The storage unit 77 stores various data such as moving image data and audio data supplied from the control unit 71.

The communication unit 78 performs wireless or wired communication with an external device. The communication unit 78 transmits various data such as moving image data supplied from the control unit 71 to a computer, an external device, or the like.

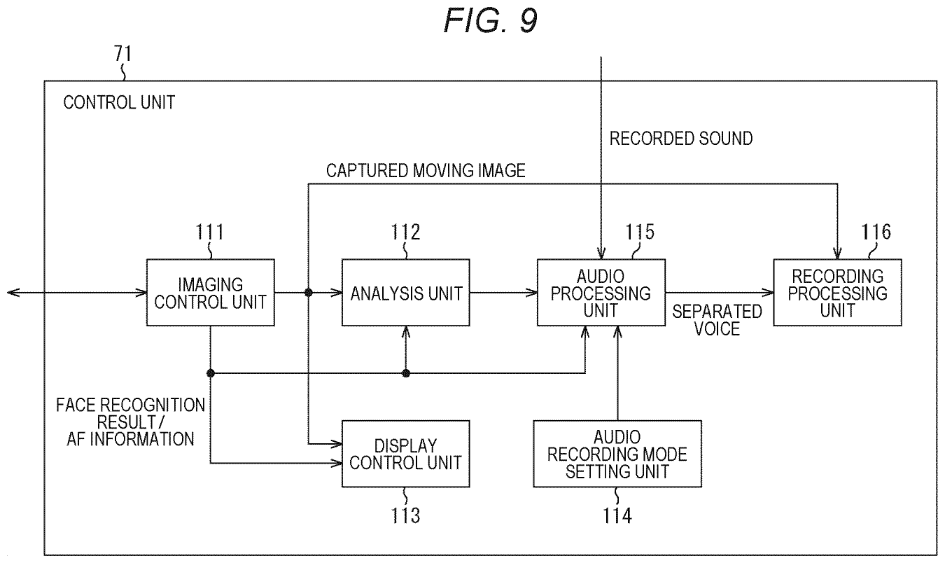

FIG. 9 is a block diagram illustrating a functional configuration example of the control unit 71. At least some of the functional units illustrated in FIG. 9 are implemented by executing a predetermined program by the CPU configuring the control unit 71.

The control unit 71 includes an imaging control unit 111, an analysis unit 112, a display control unit 113, an audio recording mode setting unit 114, an audio processing unit 115, and a recording processing unit 116. Information indicating the content of the user's operation is input to each unit in FIG. 9. The recorded sound captured by the microphone 73 is input to the audio processing unit 115.

The imaging control unit 111 controls imaging by the imaging unit 72 in FIG. 8. For example, the imaging control unit 111 analyzes a moving image captured by the imaging unit 72 and recognizes the face shown in the moving image. The imaging control unit 111 has a function of face recognition. Furthermore, the imaging control unit 111 controls the focus so as to focus on the face of a predetermined person.

The moving image captured by the imaging control unit 111 is supplied to the analysis unit 112, the display control unit 113, and the recording processing unit 116. Furthermore, the information indicating the recognition result of the face and the AF information, which is the information indicating the in-focus position, are supplied to the analysis unit 112, the display control unit 113, and the audio processing unit 115.

The analysis unit 112 analyzes the motion of the mouth of the person shown in the moving image supplied from the imaging control unit 111. For example, the timing of the utterance of each person shown in the moving image is appropriately analyzed using a recognition result of a face or the like. Information of the analysis result by the analysis unit 112 is supplied to the audio processing unit 115.

The display control unit 113 controls display on the display 11. For example, the display control unit 113 causes the display 11 to display various screens such as the setting screen and the shooting screen described above. The information supplied from the imaging control unit 111 is used to display information such as a frame representing the face to be subjected to AF and a frame representing the recognized face on the shooting screen.

The audio recording mode setting unit 114 accepts a user's operation and sets an audio recording mode. Information on the audio recording mode set by the audio recording mode setting unit 114 is supplied to the audio processing unit 115.

Furthermore, the audio recording mode setting unit 114 manages the registered voices. When the mode is set to the registration priority, the audio recording mode setting unit 114 outputs information of the registered voice selected by the user to the audio processing unit 115.

When the mode is set to the AF priority, the audio processing unit 115 separates the voice of the person to be subjected to AF from the recorded sound. The person to be subjected to AF is specified on the basis of the AF information supplied from the imaging control unit 111. Furthermore, the timing and the like at which the person to be subjected to AF is uttering are specified on the basis of the analysis result supplied from the analysis unit 112. As described above, in the audio processing unit 115, the voice is separated on the basis of the distance indicated by the AF information, the timing of the utterance indicated by the analysis result by the analysis unit 112, and the like.

Furthermore, when the mode is set to the registration priority, the audio processing unit 115 separates, from the recorded sound, a voice selected by the user from among the registered voices. The voice selected by the user as the recording target is specified on the basis of the information supplied from the audio recording mode setting unit 114.

An inference model having a recorded sound as an input and a voice for each person as an output may be prepared in the audio processing unit 115, and the voice for each person may be separated using the inference model. In this case, in the audio processing unit 115, an inference model including a neural network or the like generated by machine learning is prepared in advance.

The audio processing unit 115 separates the voice of a specific person and the environmental sound from the recorded sound by inputting the recorded sound to the inference model or the like, and outputs the voice and the environmental sound to the recording processing unit 116.

The recording processing unit 116 controls the storage unit 77 in FIG. 8 and records the captured moving image. Furthermore, the recording processing unit 116 records only the voice of a specific person and the environmental sound as the audio of the moving image. The voice of a specific person is recorded by the recording processing unit 116 with a volume larger than the environmental sound, for example.

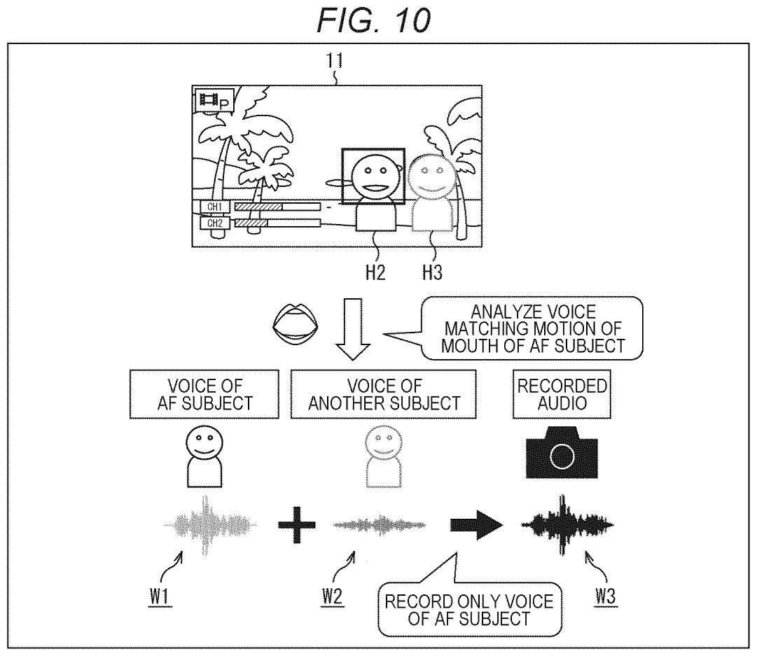

FIG. 10 is a diagram illustrating an example of separating a voice using an analysis result of the motion of the mouth.

As illustrated in the upper part of FIG. 10, in a case where imaging is performed with a subject H2 and a person H3 as subjects, when the subject H2 is an AF subject, the audio processing unit 115 specifies the position of the subject H2 on the basis of the AF information. The AF subject is a subject to be subjected to AF.

Furthermore, the audio processing unit 115 analyzes the motion of the mouth of the subject H2, which is the AF subject, using, for example, an inference model, and specifies the timing of the utterance. In this case, for example, an inference model having an image including a mouth as an input and utterance timing as an output is generated by the machine learning and prepared in advance in the audio processing unit 115.

As illustrated in the lower part of FIG. 10, the audio processing unit 115 identifies the voice of the subject H2 from among the voice of the subject H2 and the voice of the person H3 separated using the inference model and the like on the basis of the utterance timing, and extracts the voice as the voice to be recorded. The audio processing unit 115 outputs the environmental sound separated using the inference model and the like to the recording processing unit 116 together with the extracted voice of the subject H2, and causes the recording processing unit 116 to record the environmental sound and the voice of the subject H2. A waveform W1 and a waveform W2 illustrated in the lower part of FIG. 10 represent the voice of the subject H2 and the voice of the person H3, respectively. Furthermore, a waveform W3 represents a waveform of the audio including the voice of the subject H2 and the environmental sound recorded as the audio data.

### <Operation of Imaging Device 1>

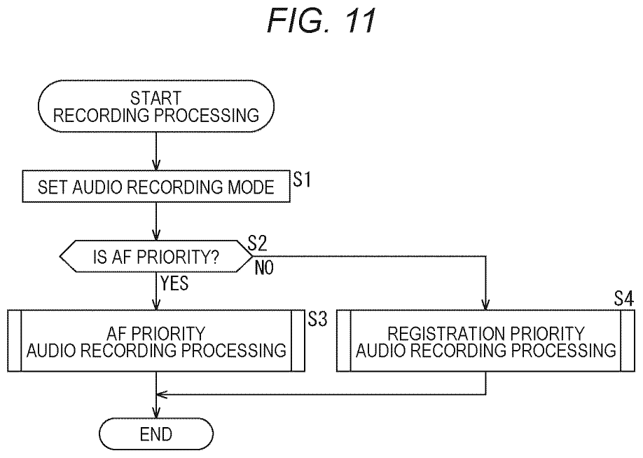

The processing of the imaging device 1 having the above configuration will be described with reference to the flowchart of FIG. 11. The processing in FIG. 11 is started, for example, when the user selects to set the audio recording mode.

In step S1, the audio recording mode setting unit 114 accepts a user's operation and sets the audio recording mode.

In step S2, the audio processing unit 115 determines whether or not the audio recording mode is the AF priority.

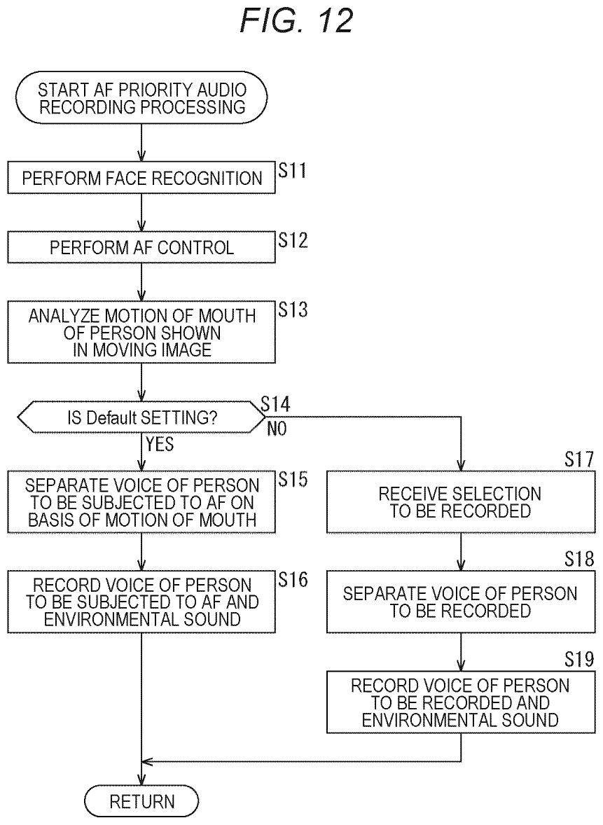

In a case where it is determined in step S2 that the audio recording mode is the AF priority, the AF priority audio recording processing is performed in step S3. The AF priority audio recording processing is audio recording processing in a case where the audio recording mode is the AF priority. The AF priority audio recording processing will be described later with reference to the flowchart of FIG. 12.

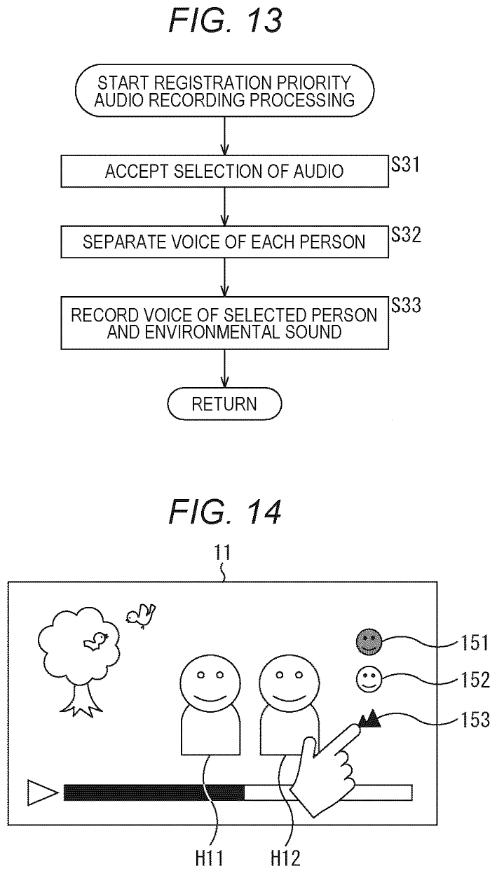

On the other hand, in a case where it is determined in step S2 that the audio recording mode is not the AF priority, the registration priority audio recording processing is performed in step S4. The registration priority audio recording processing is audio recording processing in a case where the audio recording mode is the registration priority. The registration priority audio recording processing will be described later with reference to the flowchart of FIG. 13.

### AF Priority Audio Recording Processing

Next, the AF priority audio recording processing performed in step S3 in FIG. 11 will be described with reference to the flowchart of FIG. 12.

In step S11, the imaging control unit 111 recognizes the face shown in a captured moving image.

In step S12, the imaging control unit 111 performs AF control so as to focus on the face of a predetermined person.

In step S13, the analysis unit 112 analyzes the motion of the mouth of the person shown in the moving image.

In step S14, the audio processing unit 115 determines whether or not the setting is Default setting. For example, in a case where the function of the touch sound capturing is turned off, it is determined that the setting is Default setting.

In a case where it is determined in step S14 that the setting is Default setting, in step S15, the audio processing unit 115 separates the voice of the person to be subjected to AF from the recorded sound on the basis of the motion of the mouth or the like as described above. Furthermore, the audio processing unit 115 separates the environmental sound from the recorded sound.

In step S16, the recording processing unit 116 records the voice of the person to be subjected to AF and the environmental sound as the audio data of the moving image.

On the other hand, in a case where it is determined in step S14 that the setting is not Default setting since the function of the touch sound capturing is set to on, the audio recording mode setting unit 114 accepts the selection of the voice to be recorded in step S17. The voice to be recorded is selected by selecting the face of the person as described above.

In step S18, the audio processing unit 115 separates the voice of the person to be recorded. Here, the voice to be recorded may be separated on the basis of an analysis result of the motion of the mouth or the like. Furthermore, the audio processing unit 115 separates the environmental sound from the recorded sound.

In step S19, the recording processing unit 116 records the voice of the person be recorded and the environmental sound as the audio data of the moving image.

After the audio is recorded in step S16 or step S19, the process returns to step S3 in FIG. 11, and the subsequent processing is performed.

### Registration Priority Audio Recording Processing

Next, the registration priority audio recording processing performed in step S4 in FIG. 11 will be described with reference to the flowchart of FIG. 13.

In step S31, the audio recording mode setting unit 114 accepts selection of audio performed using the setting screen as described with reference to FIG. 7.

In step S32, the audio processing unit 115 separates the voice of each person using an inference model. The inference model used here is, for example, a model in which a recorded sound in which voices of a plurality of persons and an environmental sound are mixed is an input, and a voice of each person and the environmental sound are an output.

In step S33, the recording processing unit 116 records the voice of the person selected as the voice recording target and the environmental sound as the audio data of the moving image. Thereafter, the process returns to step S4 in FIG. 11, and the subsequent processing is performed.

The series of processing as described above is continued, for example, until moving image capturing using the imaging device 1 is completed. With the above processing, the imaging device 1 can separate only the voice of the specific person specified by the user and the environmental sound from the recorded sound and record the separated voice and environmental sound as the audio data of the moving image.

### Second Embodiment (Example of Editing after Image Capturing)

The separation of the voice as described above may be performed at the time of editing after image capturing, instead of during capturing of a moving image. At the time of capturing a moving image, data of recorded sound in which voices of a plurality of persons and an environmental sound are mixed is recorded as audio data of the moving image. Editing after image capturing is performed, for example, on the imaging device 1.

FIG. 14 is a diagram illustrating a display example of an editing screen after image capturing.

The editing screen illustrated in FIG. 14 is a screen used for adjusting the volume of each sound included in the recorded sound that has been recorded.

In the example of FIG. 14, a moving image showing two persons of a person H11 and a person H12 is displayed. A slide bar indicating a reproduction position of the entire moving image is displayed at the lower part of the editing screen.

In the imaging device 1, the voice of each registered person and the environmental sound are separated from the recorded sound. For example, the voice of a specific person is registered before editing as described above. Icons 151 to 153 illustrated on the right side of the editing screen represent types of respective voices separated from the recorded sound.

For example, the icon 151 represents the registered voice, and the icon 152 represents the unregistered voice. The icon 153 represents an environmental sound.

The user can set the volume of each voice by selecting the icons 151 to 153.

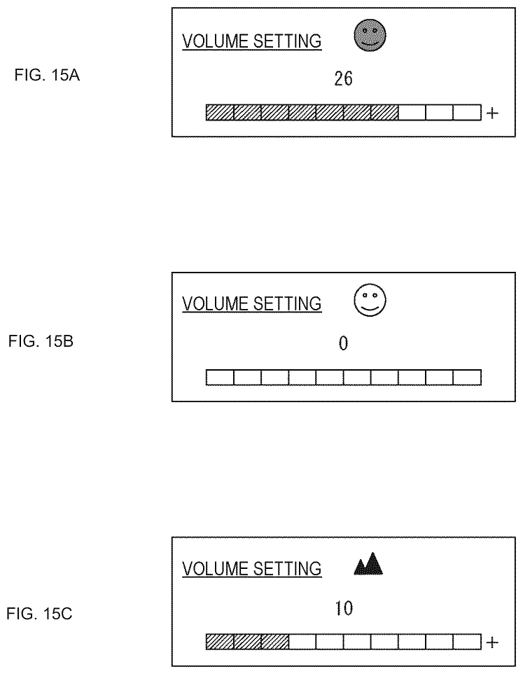

FIG. 15 is a diagram illustrating a display example of a sound volume setting screen.

The information illustrated in A of FIG. 15 is information used for setting the volume of the registered voice (a voice of the subject). In a case where the icon 151 is selected, the information illustrated in A of FIG. 15 is displayed on the editing screen.

The information illustrated in B of FIG. 15 is information used for setting the volume of the unregistered voice (a voice of a person other than the subject), and the information illustrated in C of FIG. 15 is information used for setting the volume of the environmental sound. In a case where the icon 152 is selected, the information illustrated in B of FIG. 15 is displayed on the editing screen, and in a case where the icon 153 is selected, the information illustrated in C of FIG. 15 is displayed on the editing screen.

In the example of FIG. 15, the volume of the registered voice is set to 26, and the volume of the unregistered voice is set to 0 (mute). Furthermore, the volume of the environmental sound is set to 10. Each volume illustrated in FIG. 15 is, for example, a volume automatically set by the imaging device 1. The user can manually set each volume by operating the level meter representing the volume.

Since the sound to be recorded as the audio of the moving image can be edited after image capturing, the user can concentrate on imaging without worrying about the sound to be recorded. Furthermore, the user can freely set the volume of each sound after image capturing.

### <Configuration of Imaging Device 1>

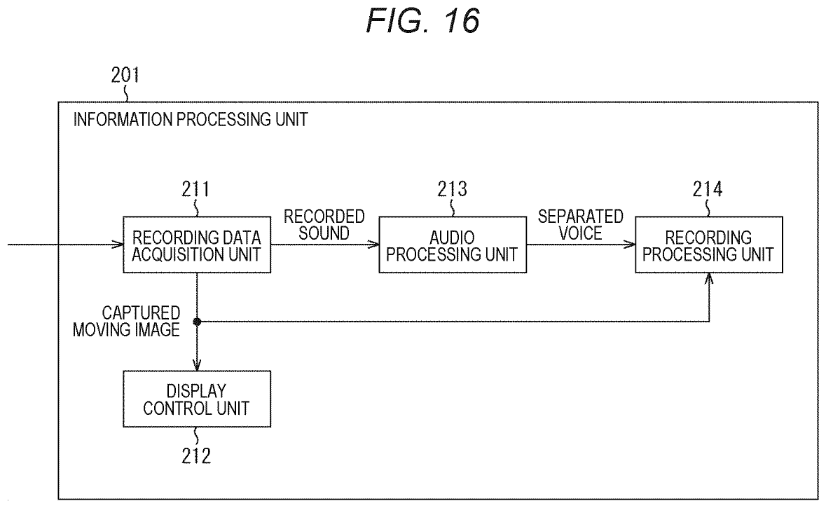

FIG. 16 is a block diagram illustrating a functional configuration example of an information processing unit 201. In the control unit 71 in FIG. 8, the information processing unit 201 that realizes an editing function after image capturing is implemented. At least some of the functional units illustrated in FIG. 16 are also implemented by executing a predetermined program by the CPU configuring the control unit 71.

The information processing unit 201 includes a recording data acquisition unit 211, a display control unit 212, an audio processing unit 213, and a recording processing unit 214.

The recording data acquisition unit 211 acquires data of the moving image and the recorded sound that has been recorded by reading the data from the storage unit 77, for example. The moving image acquired by the recording data acquisition unit 211 is supplied to the display control unit 212 and the recording processing unit 214. Furthermore, the recorded sound acquired by the recording data acquisition unit 211 is supplied to the audio processing unit 213.

The display control unit 212 causes the display 11 to display the editing screen as described with reference to FIG. 14.

The audio processing unit 213 has a function similar to that of the audio processing unit 115 in FIG. 9. That is, the audio processing unit 213 separates the voice of each person and the environmental sound included in the recorded sound supplied from the recording data acquisition unit 211. The audio processing unit 213 also performs separation of the voice by using, for example, an inference model generated by the machine learning. The voice separated by the audio processing unit 213 is supplied to the recording processing unit 214.

The recording processing unit 214 causes the storage unit 77 (FIG. 8) to record only the voice of the person selected as the recording target and the environmental sound as the audio data of the moving image according to the volume set by the user and the like.

### <Operation of Imaging Device 1>

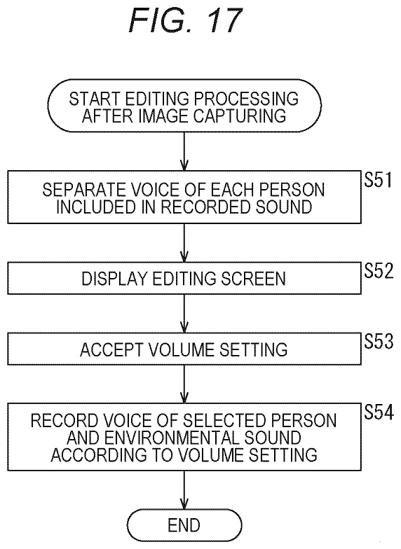

The processing of the imaging device 1 including the information processing unit 201 in FIG. 16 will be described with reference to the flowchart in FIG. 17. The processing in FIG. 17 is started, for example, when editing of the audio of the moving image is selected after image capturing.

In step S51, the audio processing unit 213 separates the voice of each person and the environmental sound included in the recorded sound using the inference model.

In step S52, the display control unit 212 causes the display 11 to display the editing screen.

In step S53, the recording processing unit 214 accepts the setting of the volume of each sound according to the user's operation on the editing screen.

In step S54, the recording processing unit 214 records only the voice of the person selected as the recording target and the environmental sound according to the volume setting.

The above processing is continued, for example, until the editing of the moving image after image capturing is completed. The imaging device 1 can adjust each volume according to the setting by the user and record the sound.

### <<Modifications>>

Editing after image capturing may be performed not on the imaging device 1 but on another device such as a PC or a smartphone. In this case, the information processing unit 201 in FIG. 16 is implemented in another device such as a PC or a smartphone.

Although one specific person is a voice recording target, voices of a plurality of persons may be recorded together with the environmental sound.

Although the separation of the voice is mainly performed using the inference model generated by the machine learning, the separation may be performed by analyzing the voice. For example, features of the voices are analyzed and separated for each voice having the same features.

The series of processing steps described above can be executed by hardware and also can be executed by software. In a case where the series of processing is executed by software, a program constituting the software is installed to a computer incorporated in dedicated hardware, a general-purpose personal computer, or the like.

The program to be installed is provided by being recorded in the removable medium including an optical disk (Compact Disc-Read Only Memory (CD-ROM), Digital Versatile Disc (DVD), and the like), a semiconductor memory, or the like. Furthermore, the program may be provided via a wired or wireless transmission medium such as a local area network, the Internet, or digital broadcasting. The program can be preinstalled in the ROM or the storage unit.

The effects described in the specification are merely examples and are not limited, and other effects may be provided.

An embodiment of the present technology is not limited to the embodiment described above, and various modifications can be made without departing from the scope of the present technology.

For example, the present technology may be configured as cloud computing in which a function is shared by a plurality of devices through the network to process together.

Furthermore, each step described in the above-described flowchart may be executed by one device or executed by a plurality of devices in a shared manner.

Moreover, in a case where a plurality of processes is included in one step, a plurality of processes included in one step may be executed by one device or by a plurality of devices in a shared manner.

### Combination Examples of Configurations

The present technology can also be configured as follows.

(1)

An imaging device including:
an audio processing unit that separates a voice of a specific person and a specific sound other than the voice of the specific person from a recorded sound recorded when a moving image is captured; and
a recording processing unit that records the voice of the specific person together with the specific sound as audio data of the moving image.
   (2)

The imaging device according to (1), in which
the audio processing unit separates an environmental sound included in the recorded sound as the specific sound, and
the recording processing unit records the voice of the specific person together with the environmental sound.
   (3)

The imaging device according to (1) or (2), further including
an imaging control unit that controls focusing on a face of an arbitrary person on the basis of a recognition result of a face shown as a subject in the moving image.
   (4)

The imaging device according to (3), in which
the audio processing unit separates a voice of a person to be focused as a voice of the specific person.
   (5)

The imaging device according to (4), in which
the audio processing unit separates a voice of a person selected by a user from among persons whose faces are recognized, as the voice of the specific person, the selected person being different from the person to be focused.
   (6)

The imaging device according to any one of (1) to (3), in which
the audio processing unit separates a voice of a registered person from the recorded sound.
   (7)

The imaging device according to any one of (1) to (6), in which
the recording processing unit records the voice of the specific person with a volume larger than a volume of the specific sound.
   (8)

The imaging device according to any one of (1) to (7), in which
the audio processing unit separates the voice of the specific person and the specific sound during capturing of the moving image to be recorded.
   (9)

The imaging device according to any one of (1) to (8), in which
the audio processing unit separates the voice of the specific person and the specific sound from the recorded sound using an inference model generated by machine learning.
   (10)

The imaging device according to any one of (1) to (3), in which
the audio processing unit separates the voice of the specific person and the specific sound after capturing the moving image on the basis of the recorded sound that has been recorded.
   (11)

The imaging device according to (10), in which
the recording processing unit adjusts respective volumes of the voice of the specific person and the specific sound according to setting by the user and records the voice of the specific person and the specific sound.
   (12)

The imaging device according to (10) or (11), further including
a display control unit that displays information indicating a type of sound separated from the recorded sound that has been recorded.
   (13)

The imaging device according to any one of (1) to (12), in which
the recording processing unit records the voice of the specific person and the specific sound as audio data of different channels.
   (14)

An imaging method, including:
by an imaging device,
separating a voice of a specific person and a specific sound other than the voice of the specific person from a recorded sound recorded when a moving image is captured; and
recording the voice of the specific person together with the specific sound as audio data of the moving image.
   (15)

A program for causing a computer to execute processing of:
separating a voice of a specific person and a specific sound other than the voice of the specific person from a recorded sound recorded when a moving image is captured; and
recording the voice of the specific person together with the specific sound as audio data of the moving image.

### REFERENCE SIGNS LIST

1 Imaging device
11 Display
111 Imaging control unit
112 Analysis unit
113 Display control unit
114 Audio recording mode setting unit
115 Audio processing unit
116 Recording processing unit
211 Recording data acquisition unit
212 Display control unit
213 Audio processing unit
214 Recording processing unit

1. An imaging device comprising:
an audio processing unit that separates a voice of a specific person and a specific sound other than the voice of the specific person from a recorded sound recorded when a moving image is captured; and
a recording processing unit that records the voice of the specific person together with the specific sound as audio data of the moving image.

2. The imaging device according to claim 1, wherein
the audio processing unit separates an environmental sound included in the recorded sound as the specific sound, and
the recording processing unit records the voice of the specific person together with the environmental sound.

3. The imaging device according to claim 1, further comprising
an imaging control unit that controls focusing on a face of an arbitrary person on a basis of a recognition result of a face shown as a subject in the moving image.

4. The imaging device according to claim 3, wherein
the audio processing unit separates a voice of a person to be focused as a voice of the specific person.

5. The imaging device according to claim 4, wherein
the audio processing unit separates a voice of a person selected by a user from among persons whose faces are recognized, as the voice of the specific person, the selected person being different from the person to be focused.

6. The imaging device according to claim 1, wherein
the audio processing unit separates a voice of a registered person from the recorded sound.

7. The imaging device according to claim 1, wherein
the recording processing unit records the voice of the specific person with a volume larger than a volume of the specific sound.

8. The imaging device according to claim 1, wherein
the audio processing unit separates the voice of the specific person and the specific sound during capturing of the moving image to be recorded.

9. The imaging device according to claim 1, wherein
the audio processing unit separates the voice of the specific person and the specific sound from the recorded sound using an inference model generated by machine learning.

10. The imaging device according to claim 1, wherein
the audio processing unit separates the voice of the specific person and the specific sound after capturing the moving image on a basis of the recorded sound that has been recorded.

11. The imaging device according to claim 10, wherein
the recording processing unit adjusts respective volumes of the voice of the specific person and the specific sound according to setting by the user and records the voice of the specific person and the specific sound.

12. The imaging device according to claim 10, further comprising
a display control unit that displays information indicating a type of sound separated from the recorded sound that has been recorded.

13. The imaging device according to claim 1, wherein
the recording processing unit records the voice of the specific person and the specific sound as audio data of different channels.

14. An imaging method, comprising:
by an imaging device,
separating a voice of a specific person and a specific sound other than the voice of the specific person from a recorded sound recorded when a moving image is captured; and
recording the voice of the specific person together with the specific sound as audio data of the moving image.

15. A program for causing a computer to execute processing of:
separating a voice of a specific person and a specific sound other than the voice of the specific person from a recorded sound recorded when a moving image is captured; and
recording the voice of the specific person together with the specific sound as audio data of the moving image.
